(19) United States
(12) Patent Application Publication
(10) Pub. No.: US 2025/0024948 A1
(43) Pub. Date: Jan. 23, 2025

(54) CREATING RECONFIGURABLE FURNITURE WITH MINIMAL PARTS

(71) Applicant: Unicube Corp., Coronado, CA (US)

(72) Inventors: Miguel Francisco Abed Ruiz, Coronado, CA (US); Derek Ryan Kirkland, Chelsea (CA); Yana Klimava, Ottawa (CA); Thomas Burn, Ottawa (CA)

(73) Assignee: Unicube Corp., Coronado, CA (US)

(21) Appl. No.: 18/708,802

(22) PCT Filed: Nov. 9, 2022
(86) PCT No.: PCT/US2022/049389

§ 371 Date: May 9, 2024

Related U.S. Application Data
(60) Provisional application No. 63/277,290, filed on Nov. 9, 2021.

(51) Int. Cl. A47C 4/02; F16B 12/52

(52) U.S. Cl. CPC A47C 4/028; F16B 12/52

(57) ABSTRACT

Furnishings are created by combining a single panel design and a single fastener design in various ways. The connector has a cap plate mounted on opposite sides of one or two panels, with a threaded connector passing through the panel(s). A handle having a cam surface is attached to one of the threaded fasteners, such that after threading together the threaded connectors, the handle can be rotated to engage the cam against a cap plate to complete tightening of the connector. The connectors can have alignment posts which pass through preformed holes in the panels.

### FIELD OF THE DISCLOSURE

The disclosure relates to modular furniture, and more particularly to creating a wide variety of furnishings from a minimal number of differing parts.

### BACKGROUND OF THE DISCLOSURE

Modular furniture systems typically include various brackets and pre-fitted parts which can be combined in particular ways to produce a finished assembly, sometimes without using tools. In some implementations, a threaded socket is affixed to one part, and a threaded shaft is affixed to another, by which the components are joined. In other implementations, a bracket having gaps or channels is affixed to one part, and the part to be assembled includes mating projections which fit into the gaps, for example in the manner of a dovetail connection. In other embodiments, washers, springs, or other components form part of the mutual connection.

### SUMMARY OF THE DISCLOSURE

In an embodiment of the disclosure, a system for creating various furnishings without a requirement for the use of tools comprises a connector including (a) a cap plate defining a cap outer face and an opposed cap inner face, (b) a first threaded extension affixed to and extending from the inner face of the cap plate, the first threaded extension terminating at an end distal from the inner face, (c) a base plate defining a base outer face and an opposed base inner face, (d) a second threaded extension extending through the base plate, the second threaded extension extending away from the base plate on a side of the base plate defining the base inner face, and (e) a handle pivotably attached at a pivot axis to the second threaded extension, the handle defining at least one cam lobe, the handle pivotable about the pivot to a first position in which at least a portion of the at least one cam lobe bears against the base plate to urge the base plate in a direction away from the pivot axis, the handle pivotable to a second position in which the at least one cam does not urge the base plate in a direction away from the pivot axis; whereby two or more panels are connectable together using one or more of the connector, wherein (i) each of the one or more connector is attachable to at least one of the two or more panels by positioning one or more of the two or more panels between the inner face of the cap plate and the inner face of the base plate, and (ii) the second threaded extension is threadably engageable with the first threaded extension to thereby clamp the connector to at least one of the two or more panels when the handle is pivoted.

In variations thereof, the system further includes at least one post affixed to and extending from one of the cap inner face or the base plate; one of the cap plate and base plate defining one or more post apertures alignable with one of the at least one posts, whereby when at least one post is passed through a post hole, the base plate is urged into a fixed radial relationship with the cap plate; the handle is substantially wider than the first threaded fastener, whereby additional leverage is gained in order to tighten the first threaded fastener using a hand without the use of tools; and/or the system further includes a resilient cap plate gasket positionable against the inner face of the cap plate, and a resilient base plate gasket positionable against the inner face of the base plate.

In another variation thereof, the system further includes an extension including an internally threaded extension channel sized to threadably receive an externally threaded one of the first and second threaded extension, and a threaded extension shaft on a side of the extension opposite to the extension channel, the extension shaft sized to be threadably received in an internally threaded one of the first and second threaded extension, the extension sized to enable the cap plate and the base plate to be threaded together at a relatively greater distance from each other than when the extension is not connected.

In further variations thereof, the panels each define a substantially planar support surface having opposed ends, each of the opposed ends forming a side extension extending away from the planar support surface; the system further includes a cushion positionable upon the planar support surface and between the side extensions; two panels are mutually connected using at least two connectors, the panels oriented with respect to each other wherein the side extensions of each of the panels extend in a direction towards the other of the two panels, each side extension of one panel aligned with a side extension of the other of the two panels, the planar support surfaces of the two panels thereby maintained at a distance from each other by the side extensions and the connectors, forming a hollow central interior; the connectors are attached to the side extensions; and/or at least one of the first and second threaded extension defining an internally threaded channel, and the other of the first and second threaded extensions defining an externally threaded shaft mateable with the internally threaded channel.

In yet further variations thereof, the at least two of the two or more panels are mutually connected by a single connector; at least two of the two or more panels are mutually connected by two connectors; the handle includes a grip portion forming a wave shape, the wave shape providing an area which can be grasped by a user of the connector when at least a portion of the handle lies flat against the base plate; the connector includes at least one post extending from one of the cap plate or base plate, the surface of the panel further defining at least one preformed hole sized to admit passage of the at least one post; and/or the system further includes a drawer, the drawer positionable within the hollow central interior.

In additional variations thereof, the one of the first and second threaded extensions having an externally threaded shaft further includes a portion positioned upon a first side of the base plate, the threaded shaft extending through an aperture in the base plate to extend away from a second side of the base plate opposite to the first side of the base plate, the head portion sized larger than the aperture in the base plate; and/or the first and second threaded extensions are magnetically attracted to each other.

In another embodiment of the disclosure, a system for creating various furnishings without a requirement for the use of tools comprises a connector including (a) a cap plate defining a cap outer face and an opposed cap inner face, (b) a first threaded extension affixed to and extending from the inner face of the cap plate, (c) a base plate defining a base outer face and an opposed base inner face, the base plate having a base aperture extending therethrough, (d) a second threaded extension extending through the base plate, the second threaded extension extending away from the base plate on a side of the base plate defining the base inner face, and (e) at least one post affixed to and extending away from one of the cap plate and base plate, the post disposed radially at a distance from the respective first or second threaded extension, (f) a handle pivotably attached to the second threaded extension at a pivot, the handle and pivot disposed on a side of the base plate corresponding to the base outer face, the handle defining at least one cam lobe, the handle pivotable about the pivot to a first position in which at least a portion of the at least one cam lobe bears against the base plate to urge the base plate in a direction away from the pivot, the handle pivotable to a second position in which the at least one cam lobe does not urge the base plate in a direction away from the pivot; whereby two or more panels are connectable together using one or more of the connector, wherein (i) each of the one or more connector is assemblable onto at least one of the two or more panels by positioning one or more of the two or more panels between the inner face of the cap plate and the inner face of the base plate with passage of two of the at least two posts of the inner cap face each passing through at least one of the two or more panels, and (ii) the first and second threaded extensions are threadable together to thereby clamp the connector to at least one of the two or more panels.

In a further embodiment of the disclosure, a connector for joining two or more components comprises a cap plate defining a cap outer face and an opposed cap inner face; a first threaded extension affixed to and extending from the inner face of the cap plate, the first threaded extension terminating at an end distal from the inner face; a base plate defining a base outer face and an opposed base inner face; a second threaded extension extending through the base plate, the second threaded extension extending away from the base plate on a side of the base plate defining the base inner face; and a handle pivotably attached at a pivot axis to the second threaded extension, the handle defining at least one cam lobe which includes a wave shape providing an area which can be grasped by a user of the connector when at least a portion of the handle lies against the base plate, the handle pivotable about the pivot to a first position in which at least a portion of the at least one cam lobe bears against the base plate to urge the base plate in a direction away from the pivot axis, the handle pivotable to a second position in which the at least one cam does not urge the base plate in a direction away from the pivot axis.

### BRIEF DESCRIPTION OF THE DRAWINGS

A more complete understanding of the disclosure, and the attendant advantages and features thereof, will be more readily understood by reference to the following detailed description when considered in conjunction with the accompanying drawings, in which:

FIG. 1 is an underside perspective view of a chair in accordance with the disclosure;

FIG. 2 is a front perspective view of the chair of FIG. 1;

FIG. 3 is a front perspective view of the chair of FIG. 1, with an alternative seat back configuration;

FIG. 4 is a perspective view of an assembled connector of the disclosure;

FIG. 5 is a side view of the connector of FIG. 4, provided with an extension component of the disclosure;

FIG. 5A is a detail view of a portion of the connector of FIG. 5, depicting an optional additional post fastener;

FIG. 6 is a cross section of the connector of FIG. 4, taken along the cross-section A of FIG. 5;

FIG. 7 is a bottom perspective view of the connector of FIG. 4;

FIG. 8 is a perspective view of the panel connector of FIGS. 1-2;

FIG. 9 is an exploded perspective view of the connector of FIG. 5;

FIG. 10 is a perspective view of an ottoman of the disclosure, incorporating panels and connectors as shown in FIGS. 1-3;

FIG. 11 is a side view of the ottoman of FIG. 10;

FIG. 12 is an exploded view of the ottoman of FIG. 10;

FIG. 13 is an exploded view of a connector as shown in FIGS. 1-3, of the type including a leg;

FIG. 14 is a central cross-section of the connector of FIG. 13;

FIG. 14A is a detailed view of a foot for the connector of FIG. 13;

FIG. 15 is a diagrammatic view of a post extension in accordance with the disclosure;

FIG. 16 is a perspective view of a couch in accordance with the disclosure, incorporating components of FIGS. 1-15;

FIG. 17 is a side view of the couch of FIG. 16;

FIG. 18 is a perspective view of an alternative leg configuration of the disclosure, which joins two connectors to a centrally disposed foot;

FIG. 19 is a perspective view of a further alternative leg configuration of the disclosure, which joins four connectors to a centrally disposed foot;

FIG. 20 is a perspective view of a connector and drawer slide in accordance with the disclosure;

FIG. 21 is a perspective view of a drawer of the disclosure;

FIG. 22 is a perspective view of a table, for example a coffee table, in accordance with the disclosure;

FIG. 23 is a diagrammatic bottom view of the table of FIG. 22, depicting the connector of FIG. 20 in use;

FIG. 24 is a perspective view of a bed incorporating components of the disclosure;

FIG. 25 is a perspective view of shelving in accordance with the disclosure, incorporating components of the disclosure;

FIG. 26 is a side view of an alternative connector in accordance with the disclosure, showing a wave shaped latch handle;

FIG. 27 is an exploded view of the connector of FIG. 26;

FIG. 28 is an exploded view of the connector of FIG. 29;

FIG. 29 is a further alternative connector in accordance with the disclosure, showing a removable wave shaped handle, and channel guides;

FIG. 30 is a cross-section through the center of the connector of FIG. 29;

FIG. 31 is a top perspective view of the connector of FIG. 29;

FIG. 32 is a bottom perspective view of the connector of FIG. 29;

FIG. 33 is a perspective view of a table formed with a single panel of the disclosure;

FIG. 34 is a perspective view of a chair of the disclosure, for example in accordance with FIG. 2, with a cushion component, and a vessel support attached using a connector of the disclosure, the vessel support shaped to support a removable container; and

FIG. 35 is a perspective view of a chair of the disclosure, provided with a protective rain/sun canopy attached using connectors of the disclosure.

### DETAILED DESCRIPTION OF THE DISCLOSURE

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities can be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

It can be advantageous to set forth definitions of certain words and phrases used throughout this patent document. The term “communicate,” as well as derivatives thereof, encompasses both direct and indirect communication. The term “discreet,” as well as derivatives thereof, references to the amount of skin exposed by a user of the garment, rather than the type of style of the garment. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A; B; C; A and B; A and C; B and C; and A, B, and C.

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The description in the present application should not be read as implying that any particular element, step, or function is an essential or critical element that must be included in the claim scope. The scope of patented subject matter is defined only by the claims. Moreover, none of the claims invokes 35 U.S.C. § 112 (f) or analogous provisions in other jurisdictions with respect to any of the appended claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanet or an essential feature of any or all the claims.

After reading the specification, skilled artisans will appreciate that certain features are, for clarity, described herein in the context of separate embodiments, can also be provided in combination in a single embodiment. Conversely, various features that are, for brevity, described in the context of a single embodiment, can also be provided separately or in any subcombination. Further, references to values stated in ranges include each and every value within that range.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

Headings are provided for the convenience of the reader, and are not intended to be limiting in any way.

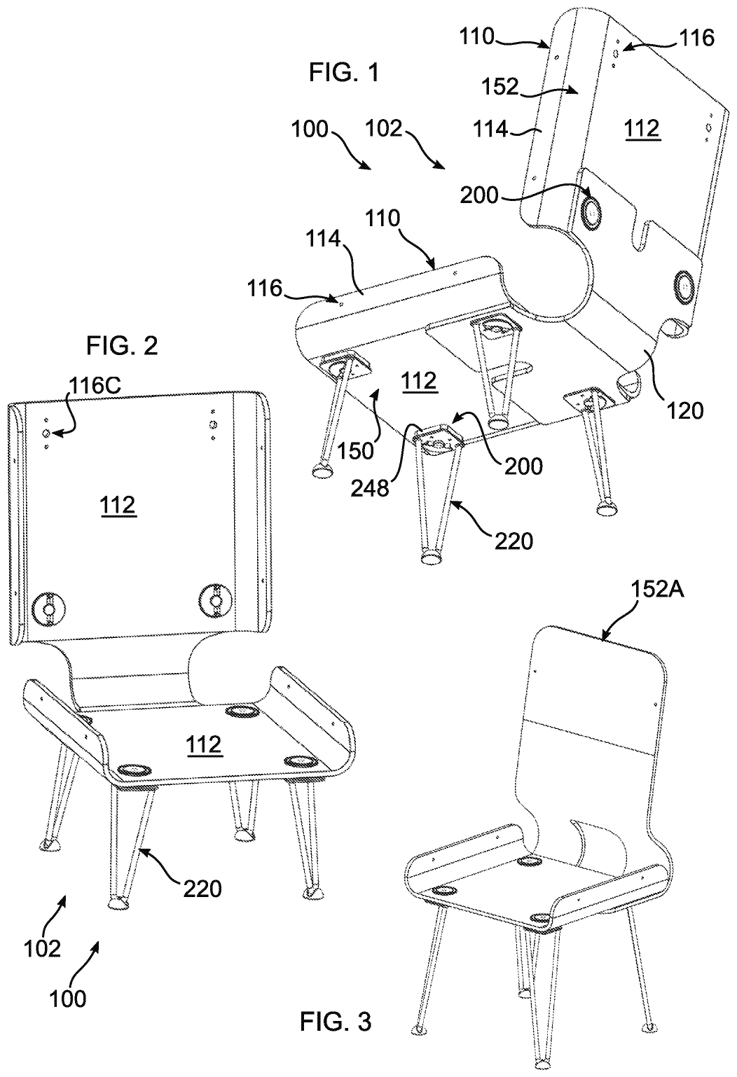

With reference to the figures, and particularly to FIGS. 1-2, a furnishing assembly 100 in accordance with the disclosure, in this example a chair 102, includes a supportive panel 110 having a planar portion 112 and side extensions 114. In the embodiment of FIGS. 1-2, panel 110 functions as a seat base 150 and a seat back 152, to form chair 102. Panels 110 include preformed apertures 116 which are positioned and aligned to enable the formation of a wide variety of furnishings, as detailed further herein.

Panels 110 are fabricated using a material that is sufficiently strong and durable for the intended purpose, and particularly for use as a component of furniture, and can include for example wood, fiberglass, carbon fiber, metal including for example steel or aluminum, a composite material, resin, or a polymeric material, as non-limiting examples.

Connectors 200, shown in detail for example in FIGS. 5-6 and 8, are used to combine panels 110 together to form a unitary furniture structure. Connectors 200 can be provided with leg extensions 220, as can be seen in detail for example in FIGS. 1 and 12-13.

In FIGS. 1 and 2, a panel connector 120 is used to join seat back 152 and seat base 150, enabling seat back 152 and seat base 150 to be structurally identical and interchangeable. Alternatively, as can be seen with reference to FIGS. 3 and 8, seat back 152A of chair 102A is formed with an integral panel portion 154, which results in the same parts count to form either the chair style of FIG. 1, or the chair style of FIG. 3. Preformed apertures 116 are provided within panel connector 120 to enable joining seat back 152A to seat base 150 in a manner otherwise identical to that of FIG. 1.

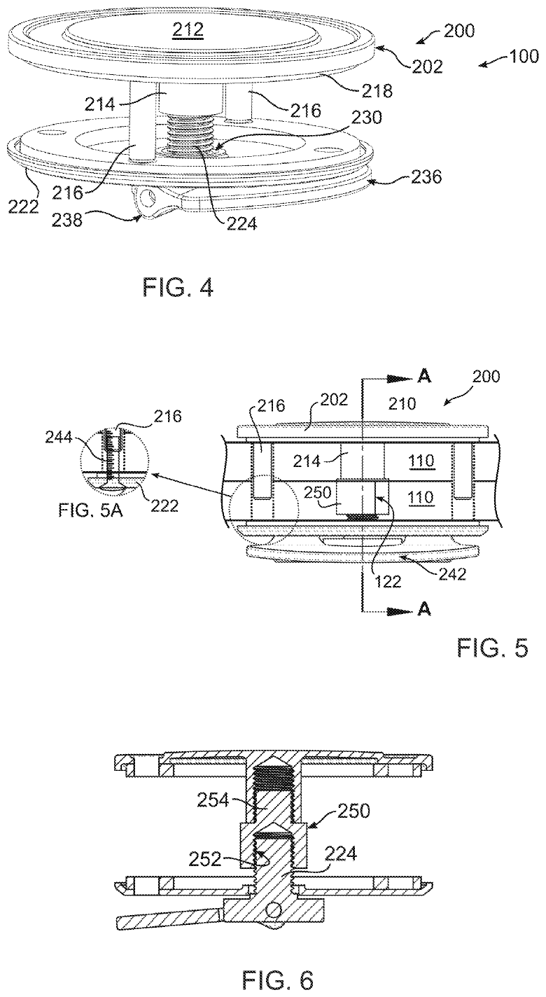

With reference to FIGS. 4-7 and 9, connector 200 includes a cap plate 212 which, when the connector is assembled, is positioned opposite to a base plate 222. Cap plate 212 is affixed to a connector cap mating portion 214, in this embodiment a screw, which extends towards base plate 222 when assembled. In this embodiment, cap mating portion is an internally threaded channel. One or more posts 216 are affixed to cap plate 212 and extend in a direction of base plate 222. A gasket 218 is positioned against a side of plate 212 from which posts 216 extend. Gaskets 218, 228 can include apertures 246 through which posts 216 or other fasteners or projections can extend.

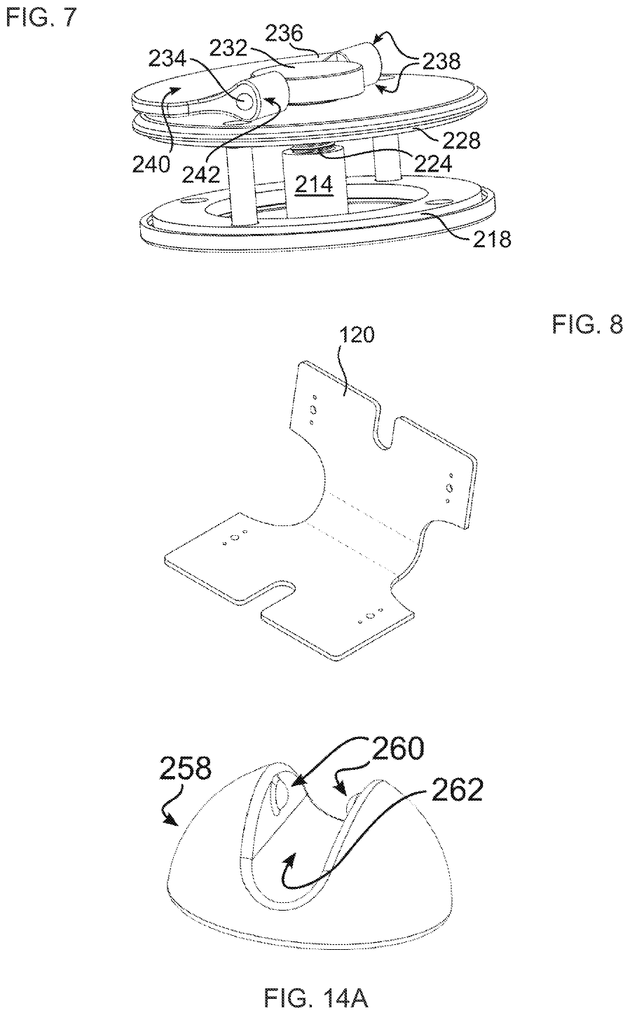

Base plate 222 is positioned opposed to cap plate 212, and has a base aperture 230 through which base mating portion 224 is passed, threadable into cap mating portion 214 when connector 200 is installed. Base mating portion 224 includes a head 232 (FIG. 7) sized larger than aperture 230. A pin 234 passes into head 232 and also into a latch handle 236, whereby at least one end of pin 234 is freely rotatable radially whereby handle 236 can be pivoted about pin 234. Handle 236 forms at least one cam lobe 238 which extends towards base plate 222 when handle 236 is in a latched position, as shown in FIG. 7, with a grip portion 240 lying against base plate 222. In the latched position, cam lobe 238 urges base plate 222 in a direction of cap plate 212 relative to head 232. An unlatched position is defined when grip portion 240 is moved away from plate 222 to position a shallow cam lobe portion 242 facing towards plate 222. Cam lobes 238, 242 can be oriented along an end of grip portion at other locations to define a latched position of grip portion 242 to be other than against base plate 222. As depicted, two lobes 238 enable grip portion 242 to be latched lying upon either face of grip portion 242.

In this embodiment, grip portion 240 of latch handle 236 is shaped as a broad flat surface which is easily grasped by a hand, and has sufficient width along a longitudinal dimension extending radially away from base mating portion 224, such that it can be rotated by hand with sufficient torque to ensure a tight connection between base plate 222 and cap plate 212. In this manner, furniture according to the disclosure can be assembled without the use of tools. Gaskets 218, 228 can be formed of a resilient material which is compressed when connector 200 is tightened, such that an axial force is continuously exerted upon base mating portion 224 and connector 200 at all times, whereby vibration and movement has a lower likelihood of causing loosening of base mating portion 224.

In an embodiment, cap mating portion 214 and aperture 230 are centrally disposed within plates 212 and 222, respectively, although they may be mutually offset to align when connector 200 is installed. Optionally, one or more of post 216 is threadably fastened to base plate 222 using a post screw 244, as depicted in FIG. 5A. Each of screw 244 can include a cam handle 242 as shown and described herein, however such screw 244 can include a smaller handle 242. A gasket 228 is positioned on a side of plate 222 from which base mating portion 224 extends.

As can be seen in FIGS. 1-3 and 5-6 two elements can be mutually affixed by a single connector 200, such as two panels 110, panel 110 and a connector 120/120A, panel 110 and seat back 152A, or other combination of elements as shown and described herein. Alternatively, as shown with respect to the front legs 220 in FIGS. 1-3 and with respect to FIGS. 4 and 7, connector 200 can be affixed to a single panel 110. As can be seen in FIG. 1, a spacer 248 can be inserted above leg 220 so that one leg 220 length can serve as both front and back legs.

In an embodiment, base mating portion 224 is retained in connection with base 222 while being axially rotatable. For example, base 222 is prevented from removal from base mating portion 224 on one side by head 232 and from an opposite side of base 222 by sizing aperture 230 to have a smaller diameter than threads of base mating portion 224, but a larger diameter than a narrowed portion (not shown) of base mating portion 224 between head 232 and the threads of base mating portion 224. In an embodiment, base 222 can be threaded onto base mating portion 224 until the narrowed portion is reached. Alternatively, base 222 can be stamped, pinched, or otherwise formed after base mating portion 224 is inserted, to form a diameter smaller than the threads and head 232.

With further reference to FIGS. 5-6 and 8, in order for a single configuration of connector 200 to be useable for both single and double panel connections, and particularly where it would be difficult to exchange base mating portion 224 with a shaft of differing length, an extension 250 can be provided, which includes an internally threaded channel 252 sized to receive base mating portion 224 on a first end, and a threaded shaft 254 positioned on a second end opposite to the first end, sized to threadably engage cap mating portion 214 of cap plate 212. Extension 250 has a length sufficient to enable a connection between base mating portion 224 and cap mating portion 214 when two elements are clamped by connector 200 and extension 250 is threaded to both base mating portion 224 and cap mating portion 214. In an embodiment, extender 250 includes an engaging exterior surface 122, which can include one or more flat surfaces which are engaged by a tool or corresponding flat surfaces within panel 110, or other surface, to prevent unwanted rotation of extension 250 during tightening.

In an embodiment, cap mating portion 214/extension 250 and base mating portion 224 are magnetically active to be magnetically attracted to each other, whereby alignment between cap mating portion 214/extension 250 and base mating portion 224 is facilitated. This can be helpful where cap plate 212 and base plate 222 block visibility of the alignment of cap mating portion 214/extension 250 and base mating portion 224 during assembly.

In one variation, the material forming cap mating portion 214/extension 250 is magnetized, or a magnet is inserted into cap mating portion 214/extension 250 or is attached exterior to cap mating portion 214/extension 250. In this variation, base mating portion 224 can be magnetized as a polar opposite to the magnetic field associated with cap mating portion 214/extension 250, whereby base mating portion 224 is directed towards cap mating portion 214/extension 250 during assembly.

It should be understood that any combination of materials resulting in an attraction between cap mating portion 214/extension 250 and base mating portion 224 can be used. For example, where one of cap mating portion 214/extension 250 and base mating portion 224 is a magnet, the other is either magnetized to be a polar opposite, or is formed with or provided with a ferromagnetic, paramagnetic, or ferrimagnetic material. Similarly, if extension 250 is pre-attached to base mating portion 224 instead of cap mating portion 214, it is configured to be magnetically attracted to cap mating portion 214.

In a still further embodiment, a cone (not shown) is positioned at the end of cap mating portion 214 or extension 250, whereby base mating portion 224 is guided into alignment with an opening into cap mating portion 214 or extension 250.

Referring now to FIGS. 10-12, it may be seen that connectors 200 and panels 110 can be combined to form other furniture structures. In the example shown, an ottoman/end table/desk/coffee table, herein ottoman 104 is formed. Two panels 110 are positioned upside down relative to each other to form an enclosed space 106. Is in other embodiments herein, preformed apertures 116 are positioned to admit posts 216, cap mating portion 214, base mating portion 224, and if included, extension 250 of connector 200, through panels 110 to enable fastening thereof. To combine two panels 110 in the manner shown in the instant embodiment, two preformed apertures 116A,B are used, which can be present in all manufactured instances of panel 110.

In the embodiment shown, a gap 108 (FIG. 11) is present between mutually facing side extensions 114, through which cap mating portion 214 and base mating portion 224 may pass, whereby no further openings, such as the larger central preformed apertures 116C (FIG. 10), need be formed upon side extensions 114. Alternatively, if it is desired to avoid gap 108, a semicircle (not shown) can be formed along facing peripheral surfaces of side extensions 114 in the location that aperture 116C would otherwise occupy. However, if a design goal is to have the smallest parts count, this would be present in all examples of panels 110, which may be undesirable in certain furniture configurations.

In FIGS. 12-14A, it may be seen that connectors 200A which join the two panels 110 along side extensions 114 do not have leg extensions 220 attached to base plate 222, while the connectors 200B affixed to the lower panel 110 do have leg extensions 220. As can further be seen in FIG. 12, base plate 222B of connector 200B includes 4 apertures 256, comprising two pairs of apertures, each pair potentially aligning with two posts 216 of the connector cap plate 212. Posts 216 are provided with a length sufficient to pass through a single panel 110 and enter into apertures 256, whereby legs 220 are affixed in any of four desired radial orientations. More orientations are possible with a greater number of apertures 256. It may be seen in the figures that legs 220 are axially offset from base 222 along their length, whereby certain such orientations may cause leg 220 to extend outwards or inwards, and left or right with respect to a center of the furnishing, to best meet the visual, convenience, and strength goals for the furnishing. This axially offset orientation can be clearly seen, for example, in FIG. 14.

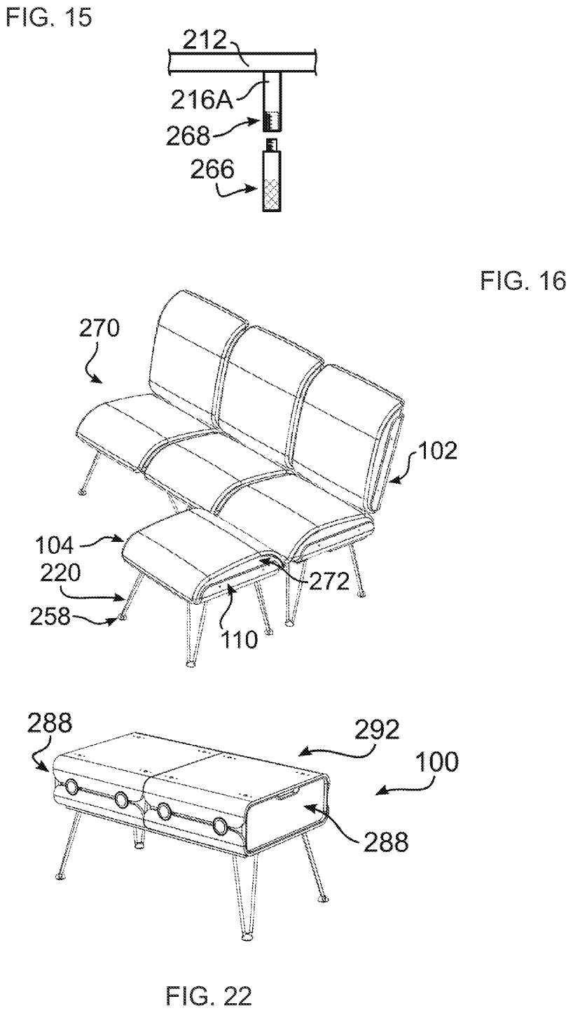

With reference to FIG. 15, where it is desired to enable posts 216 to extend through thicker or thinner panels, or more than two panels, post extensions 266 can be provided, which have a threaded screw portion at an end, which can be threaded into a threaded channel 268 provided in post 216A. Alternatively, post 216 can be threaded as shown for post extension 266, and a threaded channel (not shown) can be provided in cap plate 212, whereby post 216 is replaceable and can be provided in two or more lengths.

In a still further alternative embodiment, base plate 222 can also be provided with posts 216 (not shown) which extend in a direction of cap plate 212. In this embodiment, posts 216 of both base plate 222 and cap plate 212 can be provide with a length less than about half of the thickness of one panel 110, whereby if either one or two panels 110 are clamped by connector 200, each of cap plate 212 and base plate 222 are radially affixed with respect to an adjacent panel 110. If the two panels are otherwise prevented from mutually rotating, for example by mutual connection with another connector 200, then cap plate 212 and base plate 222 are also radially affixed relative to each other.

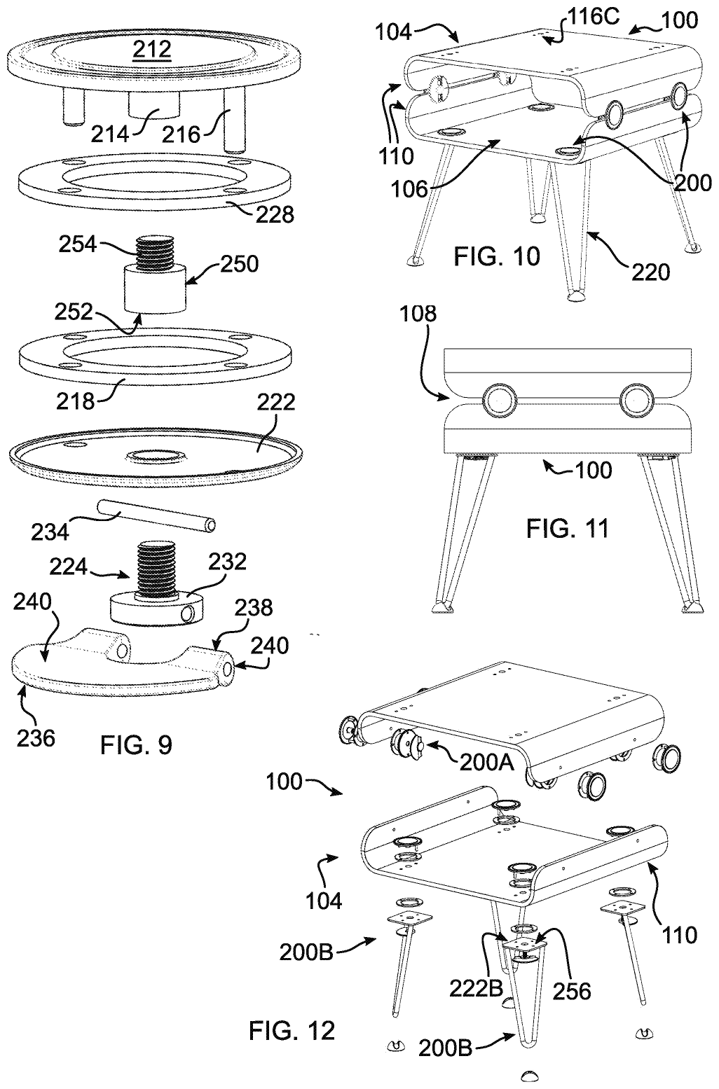

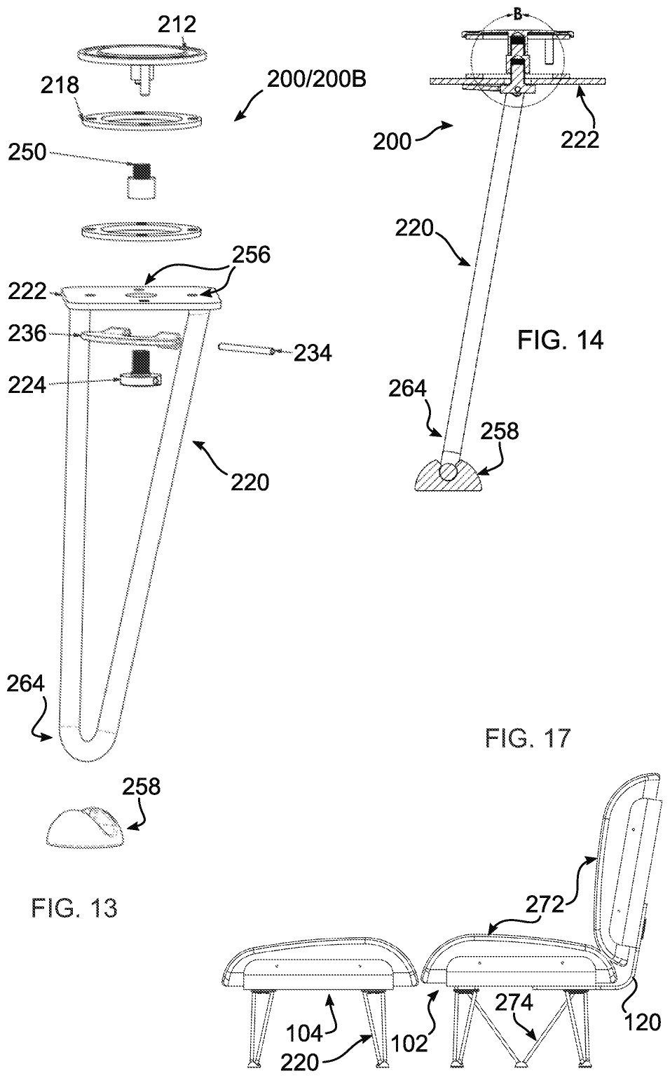

With further reference to FIG. 13-14A, it may be seen that leg 220 is formed as a hairpin bend of a rigid rod, which is affixed to plate 222B. As such, to implement a furniture leg, plate 222B with affixed leg 220 is substituted for base plate 222, resulting in only a single additional part in order to implement a furniture leg. It should be understood that other extensions or objects can be affixed to a base plate 222 in lieu of legs 222, in order to support furniture in other ways, or to support furniture accessories, such as to implement lighting, or support of other objects, such as decorative objects or planters. Further, legs 222 can have any shape, or be provided with any material, which may be affixed to base plate 222. In the embodiment shown, leg 222 is welded to base plate 222, however the combination of leg 220 and base plate 222 can be produced as a unitary part, or legs can be attached to base plate 222 by other means, such as brazing, threaded fasteners, or other strong and durable fastening method. As shown, leg 220 includes a base plate 222 and is used as a replacement for base plate 222; however, in an embodiment, leg 220 can be used together with the base plate 222 of FIG. 9, for example if it is desired to provide the finished surface of base plate 222.

With reference to FIG. 14A, a foot 258 is connectable to leg 220, to protect flooring, distribute weight, prevent scratching, reduce slippage, and/or to provide a decorative appearance. Where leg 220 has the form of a bent rod, as depicted, foot 258 can be conveniently attached t a leg distal bent end 264 during assembly. More particularly, foot 258 can include opposed nubs 260 which are pressed outwardly when leg 220 is inserted into a groove 262 of foot 258, and which resiliently resume an original position which has a smaller diameter than leg 220, and thereby prevents foot 258 from becoming disengaged from leg 220. Foot 258 can be configured to snap onto other leg 220 shapes in a similar manner, so that foot 258 can be assembled to the furnishing without the use of tools, as with all components of furniture of the disclosure. Alternatively, nubs 260 can be absent, and foot 258 can be frictionally engaged, or connected by a fastener or some other means, to leg 220.

With reference to FIGS. 16-19, a furnishing assembly 100 forms a couch and ottoman configuration 270, which can be assembled using only the components described with respect to FIGS. 1-14. More particularly, cushion components 272 can be inserted into the U-shape formed by planar portion 112 and the two side extensions 114, preventing lateral movement. Cushion components 272 can be provided with a three dimensional surface profile which provides targeted support or comfort, and can include active components such as heaters, coolers, or massage components. Cushion components 272 can be further affixed, reversibly or not as desired, using hook and loop fasteners, adhesive, threaded fasteners, or other fastening means. Preformed apertures 116 which are not being used for a connector 200 can be used to insert a fastener, for example a threaded screw, through panel 110 and into a rigid portion (not shown) of cushion component 272.

In an embodiment, configuration 270 is formed entirely from 3 chairs 102 of FIG. 1, and the ottoman 104 of FIG. 10, with the exceptions of not including the upper panel 110 and its associated connectors 200 of ottoman 104, and including the provision of cushion components 272. As should be evident, other furnishing 100 configurations can be formed using a greater or fewer number of chair 102 and ottoman 104, including longer configurations, such as theatre style row and column seating, L-shaped configurations, back-to-back configurations as may be seen in a large waiting area, facing configurations, including facing configurations which can be slid together to form a bed, possibly with an intermediate row of ottomans 104 to add width, all as non-limiting examples.

With reference to FIGS. 17 and 19, a joining leg 274 can be used to maintain a relative orientation of adjacent chairs. More particularly, a leg joining plate 276 is provided with two sets of apertures 256, each set replacing a base plate 222, whereby a first connector 200 passing through one set of apertures 256 is retained in a fixed orientation with respect to a second connector passing the other set of apertures 256. In this manner, a furnishing 100 connected to the first connector is retained in a fixed orientation to a furnishing 100 connected to the second connector. In the embodiment of FIGS. 17 and 19, two joining plates 276 are joined by a single leg 220A, which forms a single area of floor contact at a distal bent end 264. Leg 220A extends from the midpoint of each of the two joining plates 276, and can therefore be oriented to reach the floor at a more central area that is away from a perimeter of the furnishing 100. This is advantageous as leg 220A can provide a more central support, particularly useful for distributing weight support for an elongate furnishing structure such as is shown in FIGS. 16-17. Another advantage is that leg 220A end 264 is positioned away from a peripheral area which might otherwise contribute to a leg 220 interfering with the placement of feet or legs of a user, and which additionally can facilitate vacuuming or other cleaning operation.

While a single leg 220A is shown as joining two joining plates 276, a joining plate 276 can be provide with no leg 220A, and joining plates 276 are provided as individual units, each joining a pair of connectors. Alternatively, a single joining plate 276 can be provided with one or more of a leg 220 such as is shown in FIG. 1. Such one or more leg can be oriented with the leg extending more centrally, as shown and described for leg 220A.

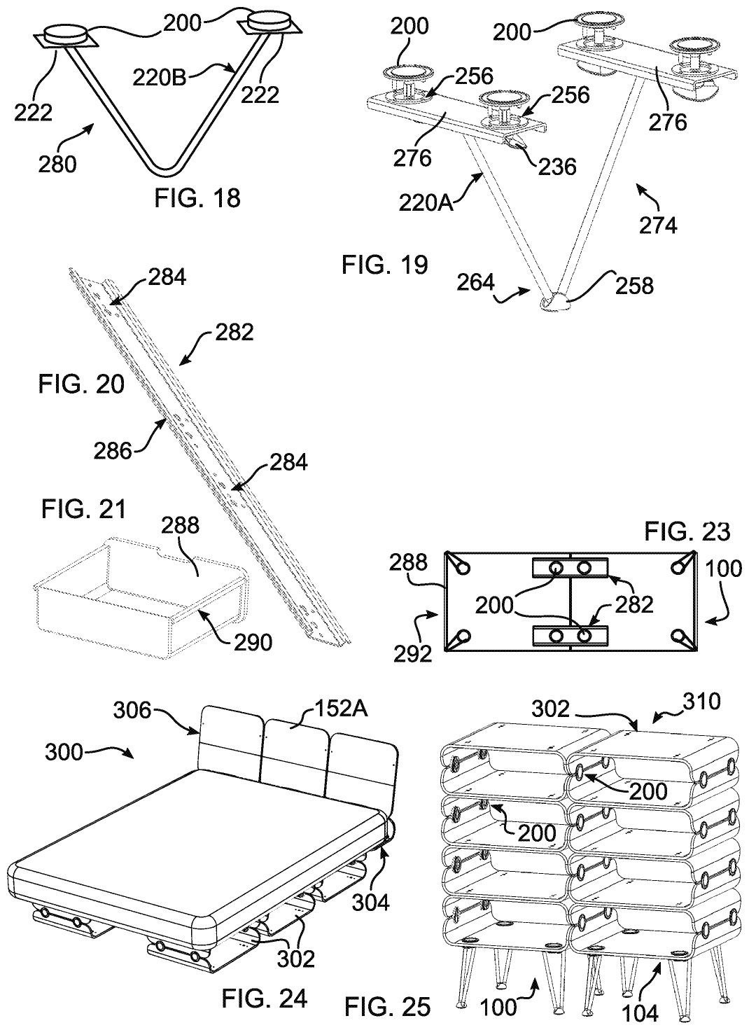

An alternative joining leg 280, shown in FIG. 18, joins two base plates 222 by a single leg 200B. If both base plates 222 of joining leg are each affixed to a connector 200 on the same furnishing 100, a function of joining two furnishings 100 is not carried out. However, a supporting function, as well as the other benefits of a centrally disposed distal bent end 264 are realized. Alternatively, joining leg 280 can connect to connectors 200 on different furnishings 100, and a joining function can also be realized. For example, the two connectors can be located in the same place on each of two adjacent furnishings 100, or can be connected diagonally to front and back connectors, respectively. Still further, leg 200B can be bent at a more acute angle, and two adjacent connectors of different furnishings 100 can be joined. In FIG. 18, a foot 258 is not shown, although foot 258 can be provided.

With reference to FIG. 20, a spanning plate 282 can be used to connect adjacent furnishings 100. Spanning plate 282 can be provided with preformed apertures 284 which align with preformed apertures of base 222 or panel 110. Plate 282 can be attached to furnishings 100 by being positioned between base plate 222 and cap plate 212, for example between base plate 222 and a panel 110. In such embodiments, the associated connector 200 can either be provided with a leg 220/220A/220B, or have no provided leg. Spanning plate 282 can have a length sufficient to join adjacent furnishings 100 at more than two connectors. In the embodiment shown in FIG. 20, there are preformed apertures for alignment with four connectors 200.

As shown in FIG. 20, spanning plate 282 includes an offset flange 286 extending along both longitudinally extending sides of plate 282, although flange 286 can extend along only one longitudinally extending side, or one or both transverse ends of plate 282. Flange 286 can thus form a guide rail for a drawer 288, as shown in FIG. 21. More particularly, a downwardly facing mating flange 290 is provided along side surfaces of drawer 288, which can be hooked onto flange 286 of plate 282, whereupon drawer 288 can be slid along flange 286 to be movable with respect to the remainder of furnishing 100. Such a drawer 288 is shown at each end of table 292 of FIGS. 22-23. Alternatively, drawer 288 can be shaped to conform to an interior dimension of panels 110 and can be thereby guided by the enclosure formed by the opposed panels 110.

With further reference to FIG. 22-23, a table 292 is assembled in the manner similar to ottoman 104 of FIG. 10, with the distinction that two of such configurations are joined together to form left and right halves 104A, 104B, and each of the left and right halves 104A/104B have two bottom connectors 200 which do not have legs 220, where the left and right halves 104A/104B are joined together to form a unitary furnishing. As can be seen in FIG. 23, connector 282 spans from an underside of the left half to an underside of the right half, clamped by two legless connectors 200 at a front side of table 292, and another connector 282 spans from an underside of the left half to an underside of the right half, clamped by another pair of the legless connectors 200 at a back side of table 292.

With reference to FIG. 24, it may be seen that a bed 300 is assembled using components of FIGS. 1-23. More particularly, support units 302 are assembled as mating panels 110 in the manner of ottoman 104, however connectors without legs 220 are used. The support units 302 can optionally be mutually secured using connectors 282 as described with respect to FIG. 23. A sufficient number of support units 302 may be used to fully support a mattress, or a lesser number of support units 302 can be used together with a supporting board 304, as shown in FIG. 24. A headrest 306 is formed using a plurality of seat back 152A (FIG. 3), which can be attached to board 304 using connectors 200, or to support units 302, using preformed apertures 116.

Turning now to FIG. 25, a bookshelf or shelves 310 are formed from a base of a plurality of ottoman 104, upon which one or more of support units 302 (FIG. 24) are stacked. Support units 302 are secured to the base ottomans 104, and successive support units are mutually connected, using connectors 200 as described elsewhere herein. Adjacent base ottoman 104 structures, as well as adjacent stacked support units 302, can be mutually connected by connectors 300 as described elsewhere herein, and as shown in FIG. 25.

Connectors 200, legs 220, panels 110, and all components of furnishings 100 as described herein can be provided with colors and finishes that correspond to a single theme which is visually appealing and complementary, as illustrated. Alternatively, such components can be provided with other themes, or selectable colors or finishes. For example, where cap plate 212 and/or base plate 222 is metallic, they can be provided with a finish that is satin or brushed, chromed or shiny, anodized, or painted. Likewise, panels 110 can be finished as a natural, stained, and varnished wood, or can be painted, or can be provided with a wood grain or other surface film coating or laminate. Similarly, if panels 110 are not made with wood, a natural finish of the material used can be displayed, such as carbon fiber or pigmented plastic.

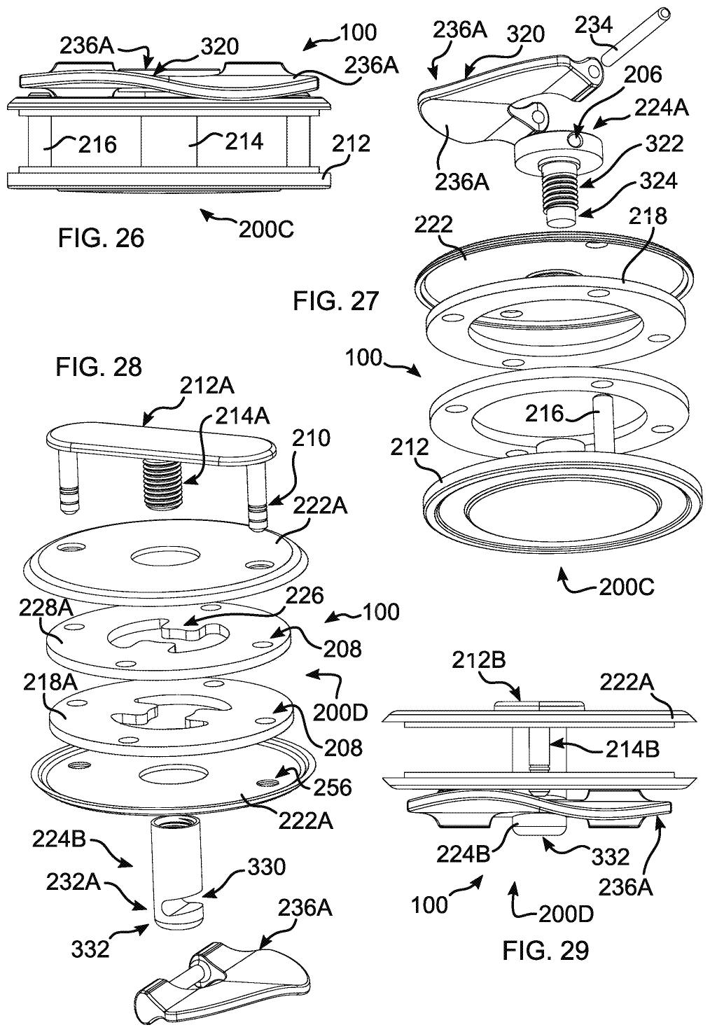

With reference to FIGS. 26-27, a connector 200C is similar to connector 200, however latch handle 236A includes a wave-shape 320, wherein a portion of the handle does not lie flat against a body of the connector, such as base plate 222, or panel 110, but instead extends in a direction away from panel 110. In this manner, a finger or a tool can easily reach between latch handle 236A and base plate 222 to thereby lift and rotate latch handle 236A towards an upright/released/unlatched position in which cam lobes 238 do not bear upon base plate 222 and the connector is loosened. In the drawings one raised wave 320 is formed, although additional waves can be provided upon handle 236A, or other raised shapes such a polygonal shape.

As can be seen in FIG. 27, base threaded portion 224A includes a threaded portion 322 and an endmost portion forming a threadless connector screw lead 324. As such, base mating portion 224A is readily inserted into connector cap mating portion 214 to be retained therein as threaded portion 322 is aligned and threaded into cap mating portion 214, facilitating assembly of furnishing 100. Further, thread pitch of threads 322 and other threaded portions herein can be selected to facilitate rapid assembly, for example having a steeper thread pitch than is standard, resulting in a greater axial movement for a given radial rotation of the fastener.

A further alternative connector 200D is shown in FIGS. 28-32, which is also similar to connector 200, and which includes a wave-shaped latch handle 236A as described with respect to FIGS. 26-27, and which further includes other features. More particularly, connector cap plate 212A is formed as a bar shape which joins connector posts 216 and cap mating portion 214A, in this embodiment an affixed screw. An additional connector base plate 222A can be provided adjacent to cap plate 212A as shown, for any of aesthetic symmetry, additional strength, or to conceal additional apertures. As such, connector cap plate 212A can be substituted with alternative plates 212A having longer or shorter posts 216A, or different mating structures for cap mating portion 214. In FIG. 29, an alternative connector cap plate 212B is provided, which includes a smaller diameter mating portion 214B, which can also be provided with a connector screw lead 324 as described elsewhere herein. Variants of Connectors 200, including connectors 200A-D and associated components can be mutually substituted herein. While connector 200B is used only where leg extensions are needed, connector 200B can nonetheless incorporate other features of the connectors as described herein.

In connector 200D, base mating portion 224B is releasably attachable to handle 236/236A. More particularly, a slot 330 is formed extending through an exterior surface of head 232A of base mating portion 224B. Pin 234 of handle 236A is placed into slot 330, whereby handle 236A becomes engaged with base mating portion 224B and can thereby rotate base mating portion 224B into threaded engagement with cap mating portion 214A. Alternatively, base mating portion 224B can be loosely hand threaded onto cap mating portion 214A, and handle 236A can be attached to form the final tightening of the mating connection, after which cam lobes 238 can be engaged by raising latch handle 236A to the latched position, causing further tightening of the mating connection between cap and base mating portions 214A and 224B. A tool engagement surface (not shown) can be provided upon base mating portion end 332 to speed and facilitate initial threading of base mating portion 224B onto cap mating portion 214A, for example using a cordless screwdriver.

With particular reference to FIGS. 28 and 31, gaskets 218A, 228A have an alternative shape including inwardly projecting protrusions 226 which are sized to extend inwards towards an axial center of the gasket, and form a diameter slightly smaller than an external diameter of base mating portion 224B. Likewise, gasket apertures 208 form a diameter slightly smaller than an external diameter of posts 216. In this manner, protrusions 226 and apertures 208 grip base mating portion 224B and posts 216 to help retain parts in mating relationship during assembly of connector 200D. Such undersized apertures can be formed in gaskets 218/228, and can be used with all variants of connector 200 herein.

Slot 330 is formed to incline towards an outer end 332 of mating portion 224B as it extends inwardly towards a center of mating portion 224B, as depicted in FIG. 28. As such, as handle 236A is rotated to a latched position, a force exerted upon pin 234 by slot 330 tends to drive pin 234 towards the center of base mating portion 224B and into a blind end of slot 330, promoting a secure engagement between pin 234 and handle 236A.

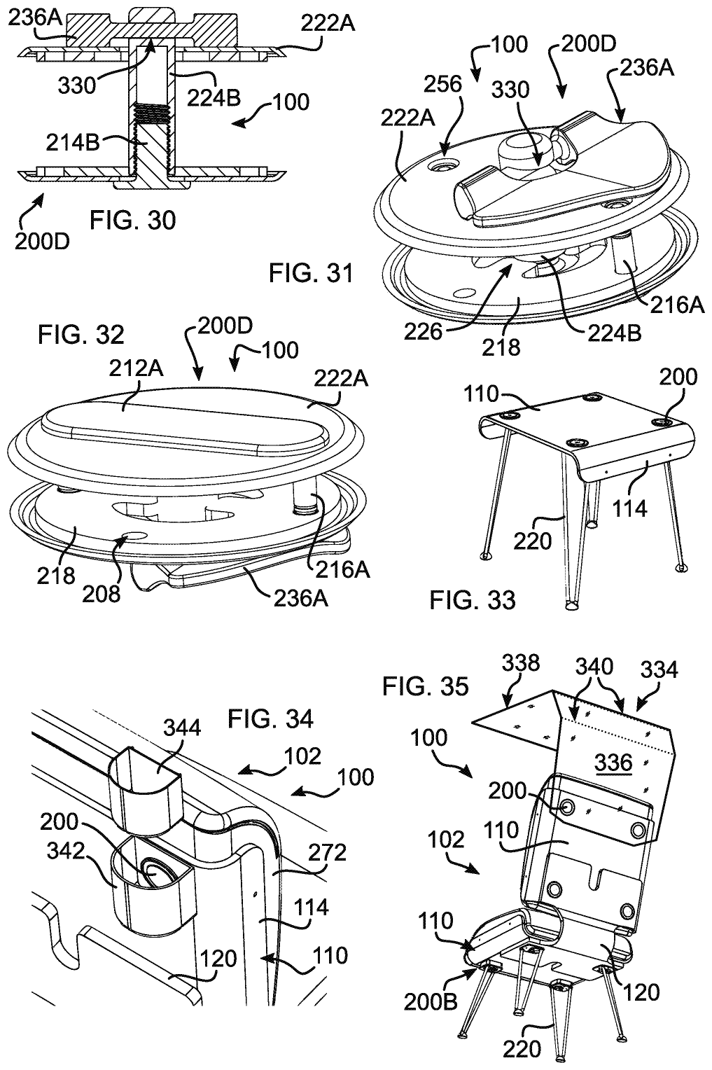

FIG. 30 is a cross section through the connector of FIG. 28, illustrating that a length of base mating portion 224B can be selected to have a length corresponding to a thickness and/or number of layers of material to connect, whereby a length of cap mating portion 214/214A can remain at a single length regardless of the thickness to be combined. In FIG. 31, gasket protrusion 226 can be seen in interference fit with base mating portion 224B.

With further reference to FIG. 28, it may be seen that posts 216A are provided with rings 210 which form a reduced diameter relative to a remainder of post 216A. Rings 210 cooperate with the reduced diameter of gasket apertures 208 to retain posts 216A in connection with gaskets 218A, 228A in loose connection during assembly. To further facilitate assembly, gaskets 218A, 228A can be adhered to its adjacent connector base plate 222A. Likewise, other gasket variants 218, 228 herein can be adhered to adjacent components to facilitate assembly, and may likewise be provided with apertures 208 of reduced diameter for a like purpose.

To further facilitate assembly, pin 234 has a diameter which is selected to provide a predetermined interference with a diameter of bore 212 (FIG. 27) in connector screw head 232. As such, a position of latch handle 236/236A is maintained at a desired orientation when released, but can be further moved when desired. A similar interference fit can be provided for other mating connections, such as insertion of posts 216 into apertures 256 in base plate 222/222A.

FIG. 33 depicts a table formed of a single supportive panel 110 mounted upon three or more leg extensions 220. In the embodiment shown the panel side extensions 114 extend downward, forming a smooth unobstructed surface which facilitates support of oversized elements, such as a tray. However, panel 110 can be mounted with side extensions 114 extending upward, in order to better contain supported contents.

With reference to FIGS. 34 and 2, it may be seen that in certain furnishing 100 configurations, there can be additional sets of panel apertures 116/116A-B which are not used for assembling the furnishing. As such, these apertures 116 are available for attaching optional accessories, such as the non-limiting examples shown in FIGS. 34-35, as examples. In FIG. 34, a connector 200 or a variant thereof as described herein is used to attach a removable container 342 to an upper portion of a chair 102. Objects can then be placed in container 342 for the convenience of a person seated upon chair 102, or for the convenience of a person seated behind or adjacent to a chair 102 so equipped. Holder 342 can be sized to support or contain objects such as books or pamphlets, an umbrella, a purse, or other accessory or object. In the example shown, an inner container 344 is sized to be supported within container 342, whereby inner container 344 can be formed without holes which may otherwise leak a liquid. As such, inner container 344 can contain a drink or a plant, or some other moist or wet object, or any material which may otherwise flow out from holes in container 342.

In a similar fashion, other containers or supports can be attached to furnishing 100 using a connector 200, whereby the other container or support is affixed in some manner, such as by a threaded fastener, to connector 200, including for example a clothes hook, clasp, or other useful holder or fastener. In this manner furnishings 100 can be configured or equipped as needed for expected personal requirements of a particular event or venue.

In FIG. 35, it may be seen that a protective canopy 334, can be attached to furnishing 100 using one or more connectors 200, where canopy 334 can be shaped to be useful for protecting a user of furnishing 100 from sun rain, sun, or dropped items, for example. In the embodiment shown, protective canopy 334 includes a substantially vertical portion 336 which extends from a panel 110, which forms a seat back portion of chair 102, to a point higher than the head of a seated person, and then forms a bend which extends to form a substantially horizontal portion 338. It should be understood that other shapes and sizes can be provided for protective canopy 334, for example a traditional umbrella shape including a vertically extending rod and a curved upper canopy (not shown), the rod attached to a connector 200, wherein the canopy is collapsible. In an embodiment protective canopy 334 is foldable, for example at hinges 344, or canopy 334 can be unmounted and remounted in a downwardly extending position. In an embodiment, canopy 334 is combined with one or more of holder 342.

It should be understood that, herein, where an internally threaded part and an externally threaded part are mated, the internally threaded part can be substituted with an externally threaded part, while the externally threaded part can then be substituted with an internally threaded part, resulting in a similar mating connection. Such reversal can occur, for example, between cap mating portion 214, extension 250 if present, and base threaded portion 224, and the variations thereof as detailed herein. An example is shown in the embodiment of FIG. 28, in which an externally threaded part 214A is attached to a variation of connector cap plate 212, and an internally threaded part is driven by a variant of handle 236.

It should be understood that the furnishings 100 depicted herein are merely representative, and a great many further configurations and embodiments of furnishings 100 can be produced using the components detailed herein. It should be further understood that although the connectors disclosed herein are described for use with modular furniture, the disclosure contemplates use of connectors 200, 200A-D for coupling components other than furniture.

All references cited herein are expressly incorporated by reference in their entirety. There are many different features of the present disclosure and it is contemplated that these features may be used together or separately. Unless mention was made above to the contrary, it should be noted that all of the accompanying drawings are not to scale. Thus, the disclosure should not be limited to any particular combination of features or to a particular application of the disclosure. Further, it should be understood that variations and modifications within scope of the disclosure might occur to those skilled in the art to which the disclosure pertains. Accordingly, all expedient modifications readily attainable by one versed in the art from the disclosure set forth herein that are within the scope of the present disclosure are to be included as further embodiments of the present disclosure.

Drawing References:

100 furnishing assembly
102, 102A chair
104 ottoman
104A, B ottoman halves
106 enclosed space
110 supportive panel
112 panel planar portion
114 panel side extension
120 panel connector
122 extension engagement surface
150 panel seat base
152, 152A panel seat back
116, 116A-B panel apertures
200, 200A-D connector
206 connector screw head bore
208 gasket aperture
210 post ring
212, 212A-B connector cap plate
214, 214A-B cap mating portion
216, 216A connector post
218, 218A connector gasket
220 legs/leg extension
222, 222A connector base plate
224, 224A-B base mating portion
226 gasket protrusion
228, 228A connector gasket
230 connector base aperture
232, 232A base mating portion bead
234 connector latch pin
236 connector latch handle
238 cam lobe extending portion
240 latch handle grip portion
242 cam lobe shallow portion
244 connector post screw
246 connector gasket aperture
248 connector spacer
250 connector extension
252 extension threaded channel
254 extension threaded shaft
256 base plate apertures
258 foot
260 foot opposed nubs
262 foot groove
264 leg distal bent end
266 connector post extension
268 threaded post channel
270 ottoman configuration
272 cushion component
274 joining leg
276 leg joining plate
282 spanning plate
284 spanning plate apertures
286 spanning offset flange
288 drawer
292 table with drawers
300 bed
302 bed support units
304 bed support board
306 bed headrest
310 shelves/bookshelf
320 grip portion wave shape
322 connector screw threaded portion
324 connector screw lead
330 base mating portion slot
332 base mating portion end
334 protective canopy
336 canopy vertical portion
338 canopy horizontal portion
340 canopy hinge
342 removable container
344 inner container

What is claimed is:

1. A system for creating various furnishings without a requirement for the use of tool, comprising:
a connector including
(a) a cap plate defining a cap outer face and an opposed cap inner face,
(b) a first threaded extension affixed to and extending from the inner face of the cap plate, the first threaded extension terminating at an end distal from the inner face,
(c) a base plate defining a base outer face and an opposed base inner face,
(d) a second threaded extension extending through the base plate, the second threaded extension extending away from the base plate on a side of the base plate defining the base inner face, and
(e) a handle pivotably attached at a pivot axis to the second threaded extension, the handle defining at least one cam lobe, the handle pivotable about the pivot to a first position in which at least a portion of the at least one cam lobe bears against the base plate to urge the base plate in a direction away from the pivot axis, the handle pivotable to a second position in which the at least one cam does not urge the base plate in a direction away from the pivot axis;
whereby two or more panels are connectable together using one or more of the connector, wherein
(i) each of the one or more connector is attachable to at least one of the two or more panels by positioning one or more of the two or more panels between the inner face of the cap plate and the inner face of the base plate, and
(ii) the second threaded extension is threadably engageable with the first threaded extension to thereby clamp the connector to at least one of the two or more panels when the handle is pivoted.

2. The system of claim 1, further including at least one post affixed to and extending from one of the cap inner face or the base plate.

3. The system of claim 2, one of the cap plate and base plate defining one or more post apertures alignable with one of the at least one posts, whereby when at least one post is passed through a post hole, the base plate is urged into a fixed radial relationship with the cap plate.

4. The system of claim 1, wherein the handle is substantially wider than the first threaded fastener, whereby additional leverage is gained in order to tighten the first threaded fastener using a hand without the use of tools.

5. The system of claim 1, further including a resilient cap plate gasket positionable against the inner face of the cap plate, and a resilient base plate gasket positionable against the inner face of the base plate.

6. The system of claim 1, further including an extension including an internally threaded extension channel sized to threadably receive an externally threaded one of the first and second threaded extension, and a threaded extension shaft on a side of the extension opposite to the extension channel, the extension shaft sized to be threadably received in an internally threaded one of the first and second threaded extension, the extension sized to enable the cap plate and the base plate to be threaded together at a relatively greater distance from each other than when the extension is not connected.

7. The system of claim 1, the panels each defining a substantially planar support surface having opposed ends, each of the opposed ends forming a side extension extending away from the planar support surface.

8. The system of claim 7, further including a cushion positionable upon the planar support surface and between the side extensions.

9. The system of claim 7, wherein two panels are mutually connected using at least two connectors, the panels oriented with respect to each other wherein the side extensions of each of the panels extend in a direction towards the other of the two panels, each side extension of one panel aligned with a side extension of the other of the two panels, the planar support surfaces of the two panels thereby maintained at a distance from each other by the side extensions and the connectors, forming a hollow central interior.

10. The system of claim 9, wherein the connectors are attached to the side extensions.

11. The system of claim 1, at least one of the first and second threaded extension defining an internally threaded channel, and the other of the first and second threaded extensions defining an externally threaded shaft mateable with the internally threaded channel.

12. The system of claim 1, wherein at least two of the two or more panels are mutually connected by a single connector.

13. The system of claim 1, wherein at least two of the two or more panels are mutually connected by two connectors.

14. The system of claim 1, the handle including a grip portion forming a wave shape, the wave shape providing an area which can be grasped by a user of the connector when at least a portion of the handle lies against the base plate.

15. The system of claim 1, the connector including at least one post extending from one of the cap plate or base plate, the surface of the panel further defining at least one preformed hole sized to admit passage of the at least one post.

16. The system of claim 9, further including a drawer, the drawer positionable within the hollow central interior.

17. The system of claim 11, the one of the first and second threaded extensions having an externally threaded shaft further including a portion positioned upon a first side of the base plate, the threaded shaft extending through an aperture in the base plate to extend away from a second side of the base plate opposite to the first side of the base plate, the head portion sized larger than the aperture in the base plate.

18. The system of claim 1, wherein the first and second threaded extensions are magnetically attracted to each other.

19. A system for creating various furnishings without a requirement for the use of tools, comprising:
a connector including
(a) a cap plate defining a cap outer face and an opposed cap inner face,
(b) a first threaded extension affixed to and extending from the inner face of the cap plate,
(c) a base plate defining a base outer face and an opposed base inner face, the base plate having a base aperture extending therethrough,
(d) a second threaded extension extending through the base plate, the second threaded extension extending away from the base plate on a side of the base plate defining the base inner face, and
(e) at least one post affixed to and extending away from one of the cap plate and base plate, the post disposed radially at a distance from the respective first or second threaded extension,
(f) a handle pivotably attached to the second threaded extension at a pivot, the handle and pivot disposed on a side of the base plate corresponding to the base outer face, the handle defining at least one cam lobe, the handle pivotable about the pivot to a first position in which at least a portion of the at least one cam lobe bears against the base plate to urge the base plate in a direction away from the pivot, the handle pivotable to a second position in which the at least one cam lobe does not urge the base plate in a direction away from the pivot;
whereby two or more panels are connectable together using one or more of the connector, wherein
(i) each of the one or more connector is assemblable onto at least one of the two or more panels by positioning one or more of the two or more panels between the inner face of the cap plate and the inner face of the base plate with passage of two of the at least two posts of the inner cap face each passing through at least one of the two or more panels, and
(ii) the first and second threaded extensions are threadable together to thereby clamp the connector to at least one of the two or more panels.

20. The system of claim 19, wherein the at least one cam lobe includes a wave shape, the wave shape providing an area which can be grasped by a user of the connector when at least a portion of the handle lies against the base plate.

21. A connector for joining two or more components, the connector comprising:
a cap plate defining a cap outer face and an opposed cap inner face;
a first threaded extension affixed to and extending from the inner face of the cap plate, the first threaded extension terminating at an end distal from the inner face;
a base plate defining a base outer face and an opposed base inner face;
a second threaded extension extending through the base plate, the second threaded extension extending away from the base plate on a side of the base plate defining the base inner face; and
a handle pivotably attached at a pivot axis to the second threaded extension, the handle defining at least one cam lobe which includes a wave shape, the wave shape providing an area which can be grasped by a user of the connector when at least a portion of the handle lies against the base plate, the handle pivotable about the pivot to a first position in which at least a portion of the at least one cam lobe bears against the base plate to urge the base plate in a direction away from the pivot axis, the handle pivotable to a second position in which the at least one cam lobe does not urge the base plate in a direction away from the pivot axis.
